(19) United States
(12) Patent Application Publication
(10) Pub. No.: US 2015/0032764 A1
(43) Pub. Date: Jan. 29, 2015

(54) PARALLEL TREE LABELING APPARATUS AND METHOD FOR PROCESSING XML DOCUMENT

(71) Applicant: Electronics and Telecommunications Research Institute, Daejeon (KR)

(72) Inventors: Kyong-Ha LEE, Daejeon (KR); Hye-Bong CHOI, Daejeon (KR); Won-Joo PARK, Daejeon (KR); Kee-Seong CHO, Daejeon (KR); Won RYU, Seoul (KR)

(21) Appl. No.: 14/444,089

(22) Filed: Jul. 28, 2014

(30) Foreign Application Priority Data
Jul. 26, 2013 (KR) 10-2013-0089112
May 12, 2014 (KR) 10-2014-0056817

(51) Int. Cl. G06F 17/30

(52) U.S. Cl. CPC G06F 17/30371; G06F 17/30306
USPC 707/755

(57) ABSTRACT

A parallel tree labeling apparatus and method for processing an eXtensible Markup Language document (XML). The parallel tree labeling apparatus for processing an XML document includes a data distributor configured to divide the XML document into a plurality of data blocks; and a labeling component configured to receive elements of each of the plurality of data blocks, perform a labeling procedure on the plurality of data blocks in parallel, and generate a final label by combining partial labels.

### CROSS-REFERENCE TO RELATED APPLICATION(S)

This application claims priority from Korean Patent Application Nos. 10-2013-0089112, filed on Jul. 26, 2013, and 10-2014-0056817, filed on May 12, 2014, in the Korean Intellectual Property Office, the entire disclosures of which is incorporated herein by reference for all purposes.

### BACKGROUND

1. Field

The following description relates to a data processing technology, and more specifically to a technology of labeling eXtensible Markup Language (XML) data.

2. Description of the Related Art

Data or a document written in eXtensible Markup Language (XML) include data itself, tags and structural information indicating relations between the tags. A query on XML data is configured as a structured query that includes not only a query on the data, but also structural information.

Tree labeling schemes are used for processing a structured query on an XML document by allocating to each element a value that is helpful in identifying a relation between elements, such as a parent-child relation and an ancestor-descendant relation. An interval-based labeling scheme and a prefix-based labeling scheme are the most widely used labeling schemes for efficiently processing a structured query on XML data.

### SUMMARY

The following description relates to a parallel tree labeling apparatus and method for expediting a tree labeling process that is required for efficiently processing a query on an eXtensible Markup Language (XML) document, according to an exemplary embodiment.

In one general aspect, there is provided a parallel tree labeling apparatus for processing an eXtensible Markup Language (XML) document, the apparatus including a data distributor configured to divide the XML document into a plurality of data blocks; and a labeling component configured to receive elements of each of the plurality of data blocks, perform a labeling procedure on the plurality of data blocks in parallel, and generate a final label by combining partial labels.

The labeling component may be a program written in accordance with a MapReduce programming model or a module that functions as the program. The labeling component may be further configured to comprise a plurality of partial labeler, each of which is configured to perform a partial labeling procedure on elements of a data block allocated thereto; and a labeling completer configured to generate the final label by collecting groups of partial labels, wherein the partial labels are grouped by shuffling the partial labels on which the partial labeling is performed in parallel by the plurality of partial labeler.

Each of the plurality of partial labelers may be configured to perform a partial labeling procedure on a data block allocated thereto, and record offset information required for combining and correcting partial labels when the labeling completer computes the final label.

The labeling completer may be further configured to generate the final label by correcting labels based on the offset information when combining the partial labels, wherein the offset information is structural information required for correction when generating the final label by combining the partial labels.

The labeling completer may further configured to generate the final label by correcting the partial labels using a correction operator when combining the partial labels.

The data distributor is further configured to divide the XML document into a plurality of data blocks in a distributed file system that supports data duplication on data block-by-data block basis.

The parallel tree labeling apparatus may further include a statistics processor configured to read the XML document divided by the data distributor, and aggregate appearance frequencies of elements for each tag name in each data block of the XML document

The statistics processor may be further configured to comprise a plurality of tag name appearance frequency estimators, each of which is configured to read a data block allocated thereto and estimate appearance frequencies of elements having a same tag name among entire elements in the allocated data block; and an appearance frequency aggregator configured to receive thee appearance frequencies from each of the plurality of tag name appearance frequency estimators, and aggregate the appearance frequencies of elements for each tag name in the entire XML document.

The parallel tree labeling apparatus may further include a data redistributor configured to distribute a volume of data using an aggregation result of the appearance frequencies computed in the statistics processor, so that an equal amount of workloads is assigned to each task of the label component.

The data redistributor may be further configured to compute average appearance frequencies of elements for tag name in the XML document by reading appearance frequencies of the elements for each tag name; in response to a tag name for which elements have appearance frequencies greater than the average appearance frequencies, dividing a list of the elements having the tag name into a plurality of lists of elements; and allocating a partition key to each of the divided lists of elements. At this point, the labeling component may be further configured to perform a shuffling operation according to a partition key provided by the data redistributor, so that an equal amount of workloads is allocated to each task for performing the labeling procedure.

In another general aspect, there is provided a parallel tree labeling method for processing an eXtensible Markup Language (XML) document, the method including: dividing the XML document into a plurality of data blocks; and receiving elements of each of the plurality of data blocks, performing a labeling procedure on each of the plurality of data blocks, and generating a final label by combining partial labels.

Other features and aspects may be apparent from the following detailed description, the drawings, and the claims.

### BRIEF DESCRIPTION OF THE DRAWINGS

FIG. 1 is a diagram illustrating an eXtensible Markup Language (XML) document that is used throughout the following descriptions for convenience of explanation of the present disclosure;

FIGS. 2 and 3 are diagrams illustrating an example in which an interval-based labeling scheme and a prefix-based labeling scheme are performed, respectively, in a logical tree model that represents structural information of the XML document shown in FIG. 1;

FIG. 4 is a diagram illustrating a configuration of a parallel tree labeling apparatus according to an exemplary embodiment;

FIG. 5 is a flow chart illustrating a partially labeling method during parallelization of an interval-based labeling scheme according to an exemplary embodiment;

FIG. 6 is a flow chart illustrating a label generating method during parallelization of an interval-based labeling scheme according to an exemplary embodiment;

FIGS. 7A and 7B are diagrams illustrating an example in which parallelization of an interval-based labeling technique is performed in a system of the present disclosure according to an exemplary embodiment; and

FIGS. 8A and 8B are diagrams illustrating an exemplary in which parallelization of a prefix-based labeling scheme is performed in a system of the present disclosure according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

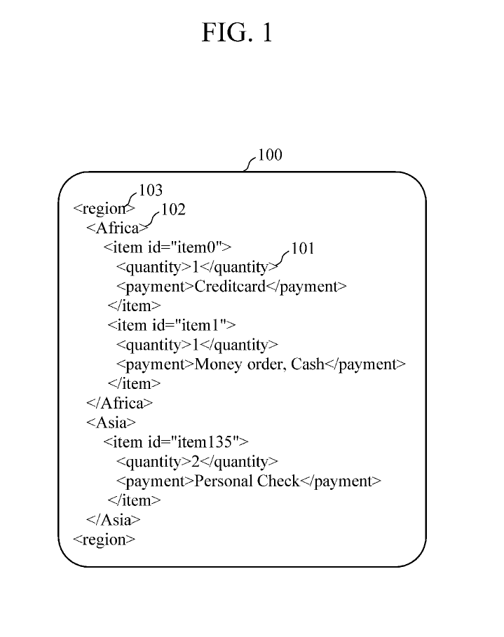

FIG. 1 is a diagram illustrating a structure of an eXtensible Markup Language (XML) file that is used as an example throughout the following description for explanation of the present disclosure.

Referring to FIG. 1, an XML document 100 includes data, tags, and structural information that indicates relations between the tags. A query on XML data is in a form of a structured query including such structural information, as well as a query on the XML data itself.

An element of the XML document 100 is composed of a start tag and an end tag. For example, as illustrated in FIG. 1, quantity element 101 is composed of start tag <quantity> and end tag </quantity>, and labels are assigned on element-by-element basis.

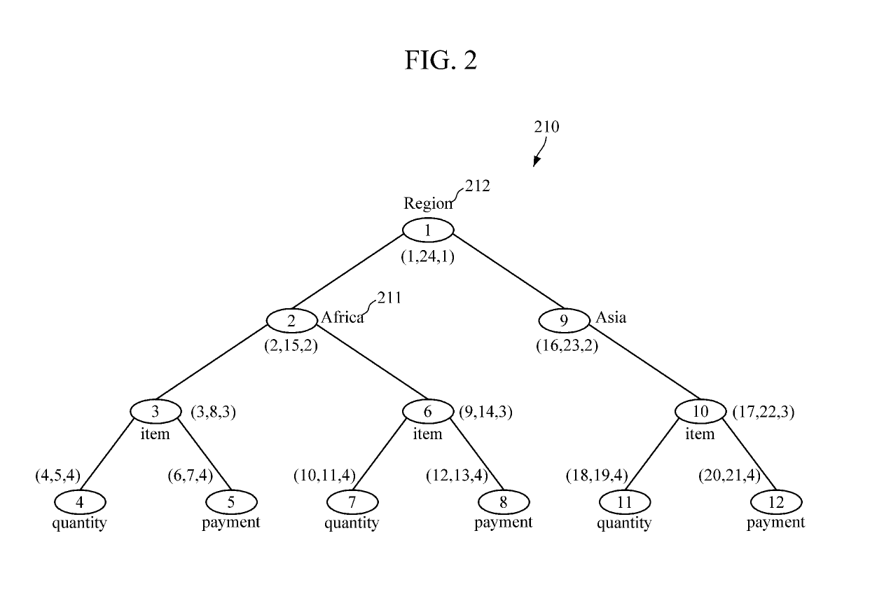

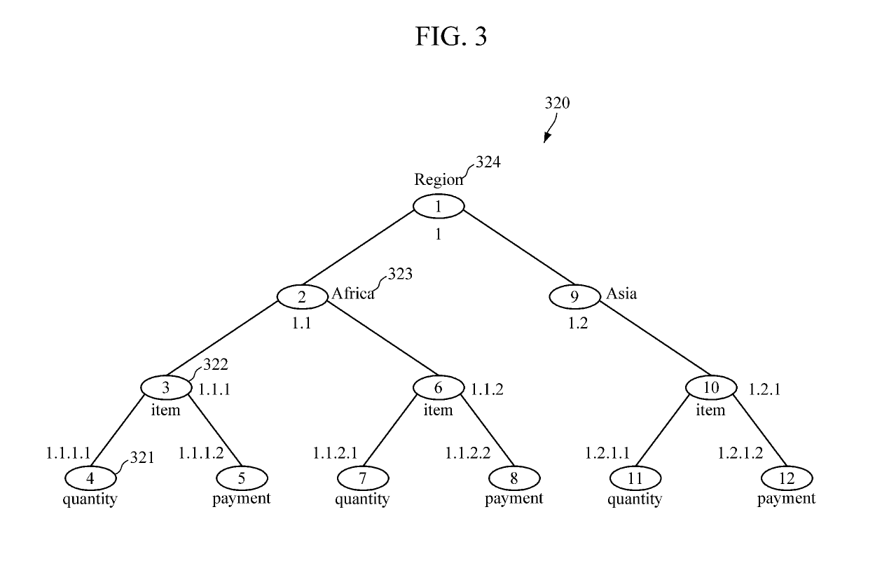

FIGS. 2 and 3 are diagrams illustrating examples in which an interval-based labeling scheme and a prefix-based scheme are performed, respectively, in a logical tree model that represents structural information of the XML document shown in FIG. 1.

Referring to FIGS. 1 and 2, an interval-based labeling scheme 210 labels the XML document 100 such that an interval of a parent or ancestor element includes an interval of a child or descendant element. A relation between two elements is determined by checking whether an interval labeled to an element include the interval labeled to the other element.

For example, in the XML document 100 in FIG. 1, Africa element 102 is included in Region element 103, so that the Africa element 102 and the Region element 103 are in a parent-child relation. Thus, as illustrated in FIG. 2, the interval <2, 15> 211 of the Africa element 102 is included in the interval <1, 24> 212 of the Region element 103. In addition, in the interval-based labeling scheme 210, a label has a level value to distinguish a parent-child relationship and an ancestor-descendant relationship. For example, the last numeric value ‘1’ in the label <1, 24, 1> 212 of the Region element 103 is a level value of a corresponding element in a tree structure. Thus, a label of each element is configured as <start tag, end tag, level>

Referring to FIGS. 1 and 3, the prefix-based labeling scheme 320 is designed such that an element has a label whose prefix is a label of the parent or ancestor of the element. Thus, by dividing a prefix from a label, it is possible to identify a parent element or an ancestor element of a specific element. For example, in the case of a prefix-based label of the first quantity element is 1.1.1.1 321, it indicates that the parent element of the first item element 322 is the first item element 322 labelled with 111 and that ancestor elements of the first item element 322 are the Africa element 323 labelled with 1.1 and the Region element 324 labelled with 1.

The interval-based labeling scheme 210 and the prefix-based labeling scheme 320, described above with reference to FIGS. 2 and 3, adapt a serial-based algorithm. That is, each of the interval-based labeling scheme 210 and the prefix-based labeling scheme 320 reads elements in an XML document and assigns labels to the elements in sequence. However, XML documents are rapidly growing both in the number and size, so it is quite challengeable to complete a labeling procedure using a serial-based algorithm, inevitably requiring considerably long time for the labeling procedure. The present disclosure solves this drawback by performing parallelization of the labeling procedure for an XML document. In particular, the present disclosure is useful in labeling a large XML document. Hereinafter, the present disclosure's technique of efficiently parallel labeling a large XML document is described with reference to the following drawings.

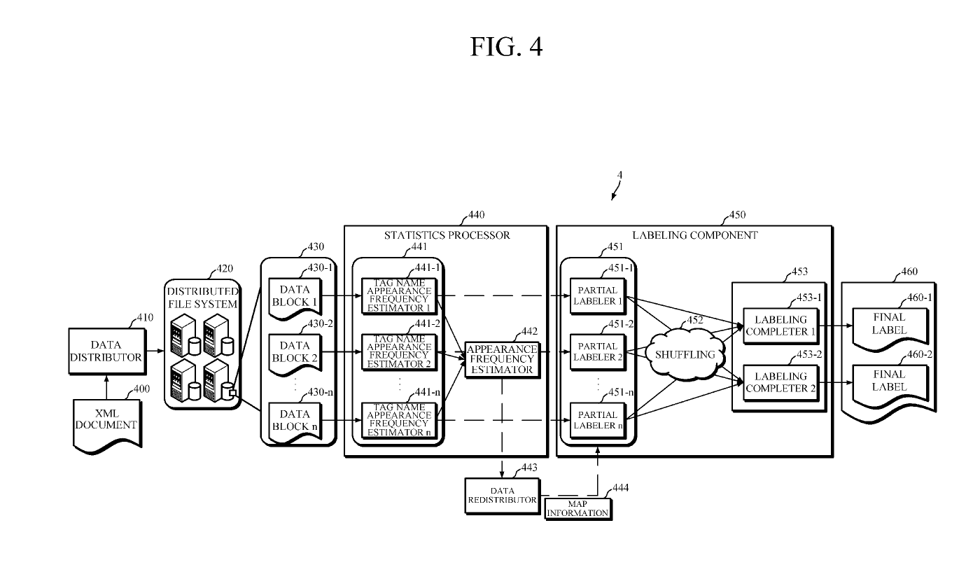

FIG. 4 is a diagram illustrating a configuration of a parallel tree labeling apparatus according to an exemplary embodiment.

Referring to FIG. 4, a parallel tree labeling apparatus 4 includes a data distributor 410 and a labeling component 450, and may further include a distributed file system 420, a statistics processor 440, the labeling component 450 and a data redistributor 443.

The data distributor 410 divides an XML document 400 into a plurality of data blocks. At this point, the XML document 400 may be distributedly stored in the distributed file system 420. The distributed file system 420 supports duplication of data on block-by-block basis in order to store the XML 400 document on which a labeling procedure is desired to be performed. At this point, the XML document 400 may be stored simply by loading the XML document 400 to the distributed file system 420, and the XML document 400 may be stored in a manner that various fixed-size data bocks of the XML document 400 are stored. For example, N number of data blocks 430-1, 430-2, . . . , 430-n are distributedly loaded to the distributed file system 420.

The data distributer 410 divides the XML document 400 into fixed size data blocks and distributedly stores the fixed size data blocks in the distributed file system 420, such as Google File System (GFS) and Hadoop Distributed file system (HDFS).

The labeling component 450 receives elements of each divided data block of an XML document, performs a partial labeling procedure on subgroups of the elements in parallel, and the generate the final label 460 by combining partial labels which are outcomes from the partial labeling procedure.

The labeling component 450 is a MapReduce-based program, which includes a partial labeler 451 and a labeling completer 453, or a module which has the same functions of the MapReduce program. MapReduce, which is a system supporting a parallel programming model as well as the parallel programming model itself, provides a method of distributing data and processing the data in parallel using only two functions Map and Reduce. A MapReduce program is performed such that each task reads a different data block of fixed size to perform a Map( ) procedure, aggregates outcomes of the Map( ) procedure on key-by-key basis, applies a Reduce( ) procedure on the aggregated outcomes, and thus obtains a final result.

Each of the partial labeler 451-1, 451-2, . . . , 452-n receives one data block at each time, independently performs a partial labeling procedure merely on elements included in the received data block, and the resultant partial labels are written based on the Map( ) procedure. The partial labels written by the respective partial labeler 451-1, 451-2, . . . , 452-n may be transmitted to the labeling completer 453 after being shuffled with reference to a partition key in accordance with a MapReduce programming model. The labeling completer 453 is a module implemented based on a Reduce( ) procedure that combines the partial labels by collecting the partial labels for each tag name or each partition key and outputs a final label. The labeling component 450 include a plurality of the partial labelers 451 and a plurality of the labeling completer 453, all of which are implemented in parallel.

When performing penalization using MapReduce, dividing data of an XML document may cause loss of structural information of the XML document. For example, if two elements in a parent-child relationship are divided into two different data blocks, the parent-child relationship is no longer valid. However, the labeling component 450 performs a labeling procedure in parallel without causing loss of structural information on elements included in an XML document, so that it is possible not just to obtain the same result as that can be obtained when using a serial algorithm, but also to expedite the whole process using parallelization. For example, when combining partial labels, the labeling component 450 corrects the partial labels using offset information or a correction operator, so that the final label may be achieved with the same result as that is obtained when the labeling procedure is performed in-serial.

The statistics processor 440 reads data blocks 430-1, 430-2, . . . , 430-n, distributedly stored in the distributed file system 420, and aggregates appearance frequencies of elements for each tag in each data block of the XML document.

The statistics processor 440 is a program written in accordance with a MapReduce programming model, or a module that executes functions of the program. The statistics processor 440 includes a tag name appearance appearance frequency estimator 441 and an appearance frequency aggregator 442. The tag name appearance appearance frequency estimator 441 functions as a mapper, whereas the appearance frequency aggregator 442 functions as a reducer.

The tag name appearance frequency estimator 441 is based on a Map( ) procedure, and n number of tag name appearance frequency estimators 441-1, 441-2, . . . , 441-n may be formed in the statistics processor 440 to execute a given function in parallel. The tag name appearance frequency estimators 441-1, 441-2, . . . , 441-n read the respective data blocks 430-1, 430-2, . . . , 430-n and estimate appearance frequencies of elements having the same tag name in each data block.

Based on a Reduce ( ) procedure, the appearance frequency aggregator 442 collects appearance frequency information computed by the respective tag name appearance frequency estimators 441-1, 441-2, . . . , 441-n, aggregates appearance frequencies of elements for each tag name in the XML document 400, and transfers the aggregated appearance frequencies to the data redistributor 443. The statistics processor 443 includes a single appearance frequency aggregator 442, and outputs from the respective tag name appearance frequency estimators 441-1, 441-2, . . . , 441-n are sent to the appearance frequency aggregator 443 as inputs.

The data redistributor 443 adjusts a volume of input data according to the aggregated appearance frequencies transferred by the statistics processors 440, so that an equal amount of workloads may be assigned to each task. To this end, the data redistributor 443 receives appearance frequencies of elements of each tag name from the statistics processor 440, and distributes workloads based on the received appearance frequencies such that an equal amount of workloads is assigned to the labeling completer 453 by the labeling component 450.

Due to simplicity in construction as a programming model and convenience given by the characteristic that a system plays a major role in parallel processing, MapReduce is widely used. However, if a specific task is required to handle a disproportionate volume of data or considerably long time is required for the specific task, the whole process is prolonged as much as the time taken by the specific task. In particular, in the case of performing a shuffling operation on the basis of tag names, there is a huge difference in a volume of input data for the Reduce procedure, thereby requiring a long time to finish a specific task, and thus, prolonging the whole process. According to an exemplary embodiment, the data redistributor 443 applies a technique of distributing an equal amount of labeling workloads to each task, so it is possible to avoid an event where disproportionate workloads are assigned to a specific task, prolonging the whole operational time of the system.

To that end, the data redistributor 443 receives appearance frequencies of elements for each tag name, and calculates an average of the appearance frequencies. In addition, the data redistributor 443 divides elements with a tag name whose appearance frequencies exceeds the average appearance frequencies. For example, in a case where average appearance frequencies is 100 and appearance frequencies of elements with tag name A is 200, the entire elements with tag name A are divided into 100 elements with tag name A_{—}1 and 100 elements with tag name A_{—}2. Then, the fact that the elements with tag names A_{—}1 and A_{—}2 are construed as elements with tag name A is recorded using map information structure, and the map information structure 444 is transferred to the labeling component 450. Each of “A_{—}1” and “A_{—}2” used for the division are referred to a partition key, and the labeling component 450 transfers partial labels to the labeling completer 453 by shuffling the elements in the partial labeler 451 according to the partition keys.

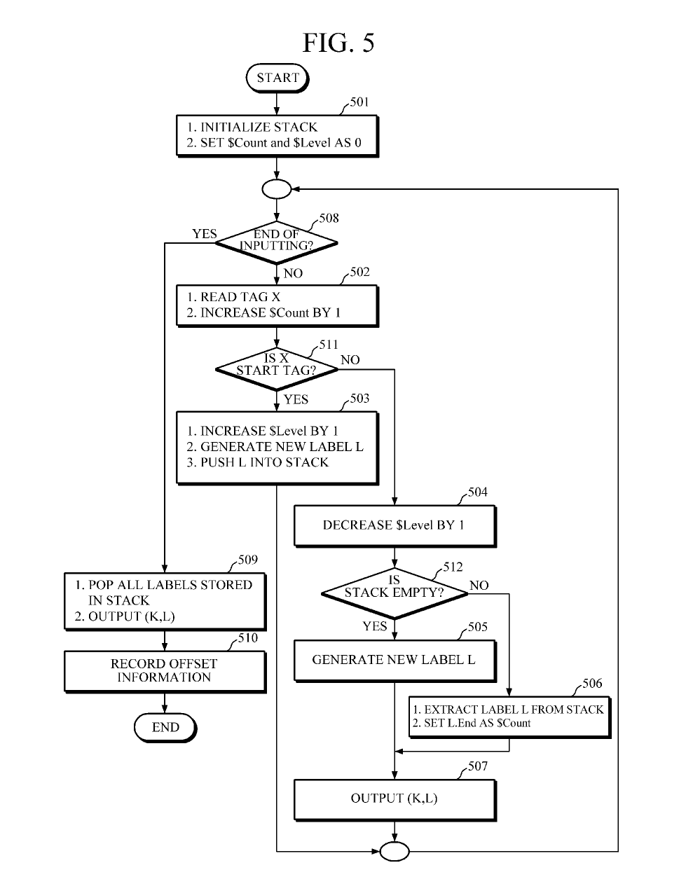

FIG. 5 is a flow chart illustrating a partial labeling method for parallelization of an interval-based labeling scheme according to an exemplary embodiment.

Referring to FIGS. 4 and 5, each of the partial labelers 451-1, 451-2, . . . , 452-n has variables $Count and $Level, and one stack for a labeling procedure. In 501, each of the partial labeler 451-1, 451-2, . . . , 452-n receives one data block, and initialize the stack and sets the variables $Count and $Level as “0” before reading the received data block.

Then, each of the partial labelers 451-1, 451-2, . . . , 452-n reads tags of the received data block in sequence, and increases the &Count value by 1 in response to reading each tag in 502. Then, each of the partial labelers 451-1, 451-2, . . . , 452 determines whether a corresponding tag is a start tag or an end tag in 511.

In a case where arbitrary tag x is a start tag, each of the partial labelers 451-1, 451-2, . . . , 452-n increases the $level value by 1, generates new label L using the current variable values, and then pushes the new label L($Count, _, $level) into a stack in 503. At this point, an end value is not specified in the interval-based label.

In a case where arbitrary tag x is an end tag, each of the partial labelers 451-1, 451-2, . . . , 452-n decreases the $level value by 1 in 504 and checks whether the stack is now empty in 512. In a case where the stack is now empty, each of the partial labelers 451-1, 451-2, . . . , 452-n generates new label L using the current values of $count and $level in 505. At this point, a start value is not specified in the label L, for example (_, $Count, $level). In a case where the stack is not empty, each of the partial labelers 451-1, 451-2, . . . , 452-n pops one label from the stack, and sets an end value of the label as the current value in $count in 506.

In both cases of operations 505 and 506, a label in a Key-Value format (K, L) is output before the end of the process in 507. Key (K) is a tag name or a partition key generated by the data redistributor 443, and Value (L) is a group of different values required for combination with a calculated label.

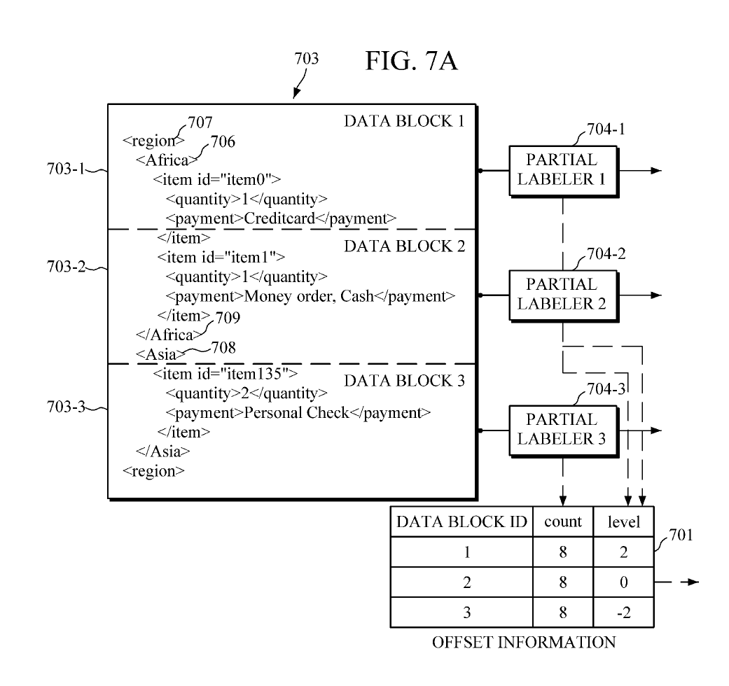

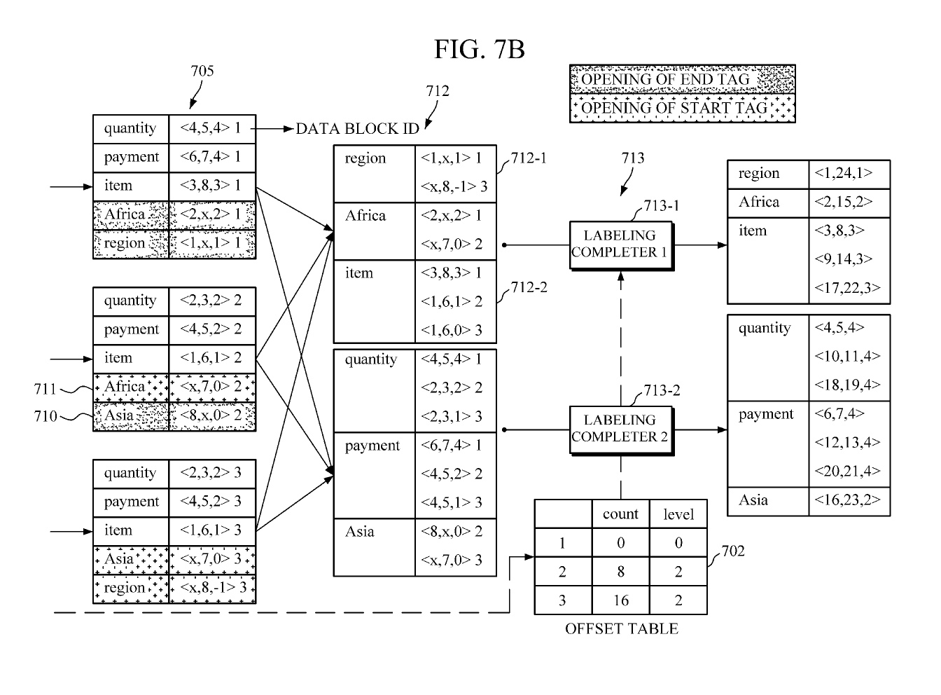

The above-described label generating process is continuously repeated as long as an unread tag remains in the corresponding data block in 508. If every tag in a data block is read, all labels stored in a stack is output in 509. Then, along with identifier (ID) of the processed data block, the current values of $count and $ level are recorded as offset information (block ID, $count, $level) in 510. The embodiment of offset information is described below with reference to FIGS. 7A and 7B.

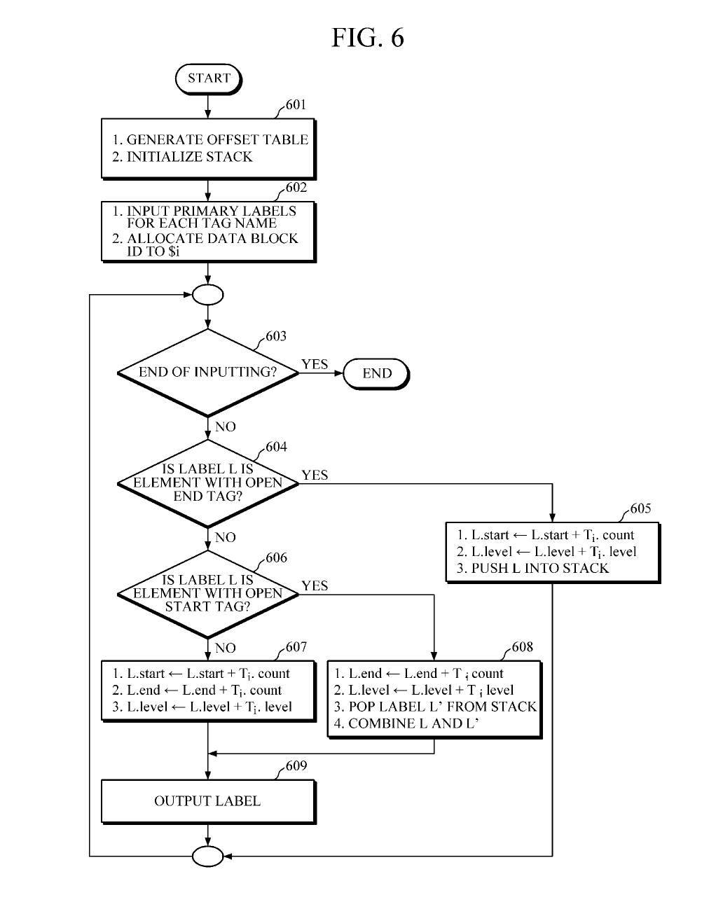

FIG. 6 is a flow chart illustrating a label generating method when parallelization of an interval-based labeling scheme is performed according to an embodiment.

Referring to FIGS. 4 and 6, the labeling completer 453 performs the following process to combine partial labels that are collected on the basis of tag names or partition keys.

Firstly, the labeling completer 453 generates an offset table in 601 by reading offset information generated for each data block from the distributed file system 420. An offset table is structural information that contains information required for correction to be performed when generating a final label by combining partial labels. For example, an offset table for interval-based labeling has two columns values, that is, a count value and a level value. In the offset table, a value in the count column of the first row is 0, and a value in the count column of the ith row indicates a sum of values of the count column from offset information corresponding to the first data block to offset information corresponding to the (i−1)-th data block. Similarly, in the offset table, a value in the level column value of the first row is 0, and a value of the level column of the ith row indicates a sum of the values in the level column inform offset information corresponding to the first data block to offset information corresponding to the (i−1)-th data block. For example, in a case where values of $count and $level in offset information corresponding to the first data block are 8 and 2, respectively, a value in the count column of the second row in the offset table is 8 that is obtained by adding 8 to 0, whereas a value in the level column of the second row in the offset table is 2 that is obtained by adding 2 to 0.

Then, the labeling completer 453 initializes the stack in 601, and receives partial labels for a specific tag name. To make sure which label comes from which data block, the labeling completer 453 extracts data block ID from a Key value and allocates the data block ID to variable $i in 602. Then, the following process is repeated until every partial label is processed.

First, in 604 and 606, the labeling completer 453 determines whether predetermined label L has an undefined end value or an undefined start value.

If the predetermined label L has an undefined end value, the labeling completer 453 adds a count value of the ith row in the offset table, that is, a value corresponding to (Ti.count), to a start value of the predetermined label L, that is, a value corresponding to (L.start), and adds a level value of the ith row in the offset table, that is, a value corresponding to (Ti.level), to a level value of the predetermined label L, that is, a value corresponding to (L.level). Then, the labeling completer 453 pushes the obtained label L into the stack in 605. For example, suppose that one of the labels allocated to the region element is <1, x, 1> 1, where the end value is undefined. In this case, by adding the count value of the first row in the offset table, that is, 0 in (T1.count), to a start value of the predetermined label L, that is, a value in (L.start), and adding the level value of the first row in the offset table, that is, 0 in (T1.level), to a level value of the predetermined label L, that is, a value in (L.level), the labeling completer 453 generates a label of <1, x, 1>.

If the predetermined label L has an undefined start value, the labeling completer 453 adds a count value of the ith row in the offset table, that is, a value corresponding to (Ti.count), to an end value of the predetermined label L, that is, a value corresponding to (L.end), and adds a level value of the ith row in the offset table, that is, a value corresponding to (Ti.level), to a level value of the predetermined label L, that is, a value corresponding to (L.level) in 608. For example, supposed that one of the labels allocated to the region element is <x, 8, −1> 3, where the start value is undefined. In this case, by adding the count value of the third row in the offset table, that is, 16 corresponding to (T3.count), to an end value of the predetermined label L, that is, a value corresponding to (L.end), and adding the level value of the third row in the offset table, that is, 2 corresponding to (T3.level), to a level value of the predetermined label L, that is a value corresponding to (L.level), the labeling completer 453 generates a label of <x,24,1>. Then, the labeling completer 453 pops a specific label L′ and combines the predetermined label L therewith in 608, and then output a final label in 609. Herein, the combination is completed by setting an empty end value of the specific label L′ as the end value of the predetermined label L.

In the other cases except for the above-described ones, the labeling completer 453 generates a final label L in 607 by adding a level value of the ith row in the offset table, that is a value corresponding to (Ti.level), to a start value and an end value of the predetermined label L and adding a level value of the ith row in the offset table, that is a value corresponding to (Ti.level), to a level value of the predetermined label L, that is, a value corresponding to (L.level). Then, the labeling completer 453 outputs the final label L in 609. For example, suppose that one of the labels of item element is <1, 6, 1> 2, where the end value is defined. In this case, by adding the count value of the second row in the offset table, that is, 8 corresponding to (T2.count), to a start value and an end value of the predetermined label, that is, values corresponding to (L.start) and (L.end), and adding the level value of the second row in the offset table, that is, 2 corresponding to (T2.level), to a level value of the predetermined label, that is, a value corresponding to (L.level), the labeling completer 453 generates a label of <9, 14, 3>. An embodiment about how to generate a final label using an interval-based labeling scheme is described in detail with reference to FIGS. 7A and 7B.

FIGS. 7A and 7B are diagrams illustrating an example in which parallelization of an interval-based labeling scheme is performed in a system of the present disclosure according to an exemplary embodiment.

Referring to FIGS. 7A and 7B, in a case where an XML document 703 is distributedly stored in three data blocks 703-1,703-2 and 703-3 in a distributed file system, partial labelers 704-1,704-2 and 704-3 are provided, and each of partial labelers 704-1,704-2 and 704-3 receives a different data block, performs a partial labeling procedure on the received data block, and outputs partial labels 705. At this point, as offset information in the distributed file system, each of the partial labelers 704-1,704-2 and 704-3 stores final values of $count and $level regarding the respective data blocks along with data block IDs.

For example, the partial labeler 1 704-1 reads a data block 1 703-1 and outputs five labels in total. At this point, both Africa element 706 and region element 707 have start tags in the data block 703-1, but not end tags. Thus, each of the Africa element 706 and the region element 707 has a label with an undefined end value. Similarly, as both of the Africa element 706 and the region element 707 have undefined end tags in the data block 1 703-1, a value for variable $level to be recorded in the distributed file system is set as 2. In addition, a value for variable $count is increased in response to appearance of a tag regardless of a type thereof, so a value for variable $count is set as 8 by reading all the 8 tags from the data block 1 703-1.

Asia element 708 has a start tag in the data block 2 703-2, but not an end tag, so a label 710 of the Asia element 708 has an undefined end value. However, Africa element 709 does not have a start tag in the data block 3 703-3, since the start tag thereof appears in the data block 1 703-1. Thus, a label 711 of the Africa element 709 with respect to the data block 2 703-2 is output with an undefined start value.

Outputs of the partial labelers 704-1,704-2 and 704-3 are in a Key-Value format, as shown in the reference number 712. Herein, ‘Key’ indicates a tag name, and ‘Value’ indicates a combination of a label and block block ID. Partial labels are shuffled in accordance with a MapReduce programming model, classified into groups on the basis of keys, that is, tag names, and then allocated to the labeling completer 713 that operates based on a Reduce procedure.

For example, two labels <1, x, 1> and <x, 8, −1> (712-1) for region element are gathered to be transferred to a labeling completer 1 713-1. The labeling completer 1 713-1 combines the two labels 712-1 with reference to an offset table 702. With respect to the region element, two labels coming from the data blocks 1 703-1 and the data block 3 703-3 are combined, so that values of the first and third rows in the offset table 702 are added to be set as a label, and the label is combined with different label. That is, <1, x, 1> of the region element in the data block 1 703-1 is set as <1, x, 1> by adding values of the first rows in the offset table 702 thereto; <x, 8, −1> of the region element in the data block 3 703-3 is set as <x, 24, 1> by adding values of the third values in the offset table 702 thereto; and then the two labels <1, x, 1> and <x, 24, 1> are combined to generate new label <1, 24, 1>.

On the other hand, labels 712-3 for item elements are fully computed in each data block, so it is not necessary to combine the labels 712-2, and thus, a final label may be generated simply adding values of a corresponding row in the offset table to the labels 712-2.

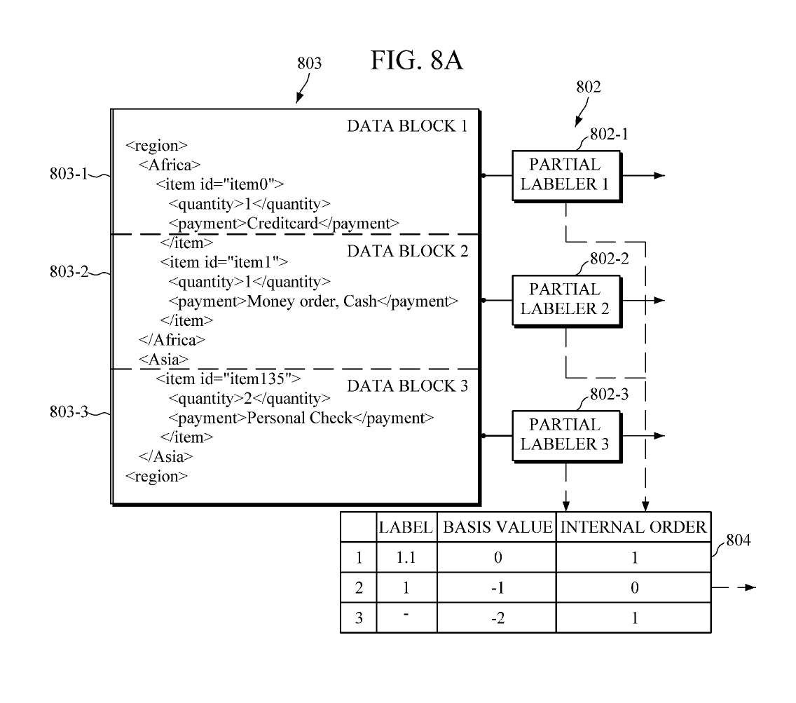

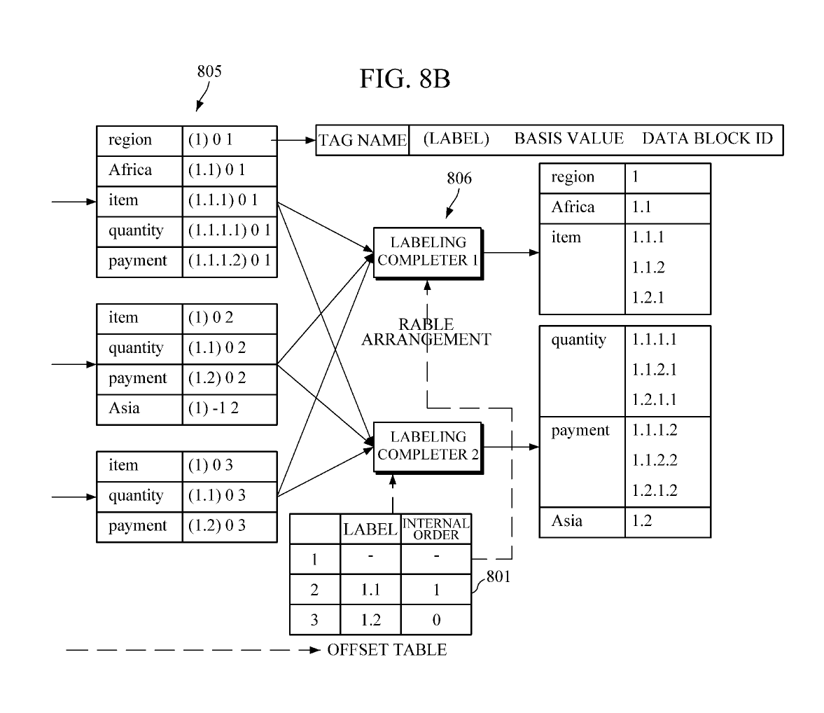

Meanwhile, parallelization of a prefix-based labeling scheme is also performed in the same way as described above with reference to FIG. 4, but it uses a correction operator to generate a label, instead of combining partial labels. Hereinafter, parallelization of a prefix-based labeling scheme is described with reference to FIGS. 8A and 8B.

FIGS. 8A and 8B are diagrams illustrating an example in which parallelization a prefix-based labeling scheme is performed in a system of the present disclosure according to an exemplary embodiment.

Referring to FIGS. 8A and 8B, partial labelers 802-1,802-2 and 802-3 performs a partial labeling procedure on elements included in respective data blocks 803-1,803-2 and 803-3. At this point, each of the partial labelers 802-1,802-2 and 802-3 has vector V and variable $o, wherein the vector V is for storing a label of a parent element of a predetermined element, and the variable $o is for storing an internal order value of the predetermined element.

At the beginning, each of the partial labelers 802-1,802-2 and 802-3 initializes values of the vector V and the variable $o. Then, at each time when any start tag appears, each of the partial labelers 802-1,802-2 and 802-3 generates a new label with a value for the vector V, which is greater than a value for the variable $o by 1, and inserts the new label into a value for the vector V whereas resetting a value for the variable $o as 0. Since the first value of the variable $o is 0, an output label is set as 1 and then the label of 1 is inserted into the vector V. However, a start tag of Africa element has 1 as a value for the vector V and 0 as the variable $o, so that a label of 1.1 is generated.

When an end tag of any element appears, each of the partial labeler 802-1,802-2, and 802-3 cuts a prefix from a label stored as a value for V and set the prefix as a value for $o as long as the vector V is not empty. If the vector V is empty, the variable o is reset as 0. For example, quantity and payment elements both have start tags and end tags in the data block 1 803-1. When the partial labeler 1 802-1 meets the end tag of the quantity element, a label of 1.1.1.1 is already stored in the vector V. The vector V is set as 1.1.1 which is obtained by removing prefix 1 from the label 1.1.1.1, and the variable $o is set as the removed prefix 1. Then, when the partial labeler 1 802-1 meets the start tag of the payment element, ($o+1) is added to the vector V of 1.1.1 so that a label of 1.1.1.2 is output with respect to the payment element

Using the above-described method, the partial labelers 802-1, 802-2, and 802-3 perform a partial labeling procedure on elements in the respectively allocated data blocks. Then, when the process ends, each of the partial labelers 802-1, 802-2, and 802-3 stores a final state values of the vector V and $o in a distributed file system, along with data block ID, in 804. A basis value is stored together with the final state values, the basis value indicating the number of end tags which exist in a corresponding block data without corresponding start tags. The basis value is used in determining the number of prefixes that are removed from the vector V and then are referred to for computation of a final label. A partial label is output in a Key-Value format, as shown in 805, in which tag names/partition keys are set as Key and a combination of a partial label, a basis value, data block ID is set as Value.

Each of the labeling completer 806-1 and 806-2 computes and outputs a final label by correcting partial labels with reference to an offset table 801 written based on offset information 804 that is recorded at a time when the whole process ends, wherein the partial labels are grouped on the basis of tag names. For parallelization of interval-based labeling, the present disclosure uses a single correction operator to write an offset table and corrects labels based on the offset table.

Table 1 shown as below explains an operational principle of a label correction operator that is used for correcting labels in the case of parallelization of an interval-based labeling scheme according to an exemplary embodiment.

TABLE 1
$X ⊙ Y ≡ \{ \begin{matrix}〈 {x}_{1} , {x}_{2} , … , {x}_{m} , ( {y}_{1} + {l}_{x} ) , {y}_{2} , … , {y}_{n} , 0 , {l}_{y} 〉 & if {b}_{y} = 0 \\ 〈 {x}_{1} , {x}_{2} , … , {x}_{m + {b}_{y}} , 0 , {x}_{m + {b}_{y} + 1} + {l}_{y} 〉 & \begin{matrix}if {b}_{y} \neq 0 , \\ n = 0\end{matrix} \\ 〈 {x}_{1} , {x}_{2} , … , {x}_{m + {b}_{y}} , ( {x}_{n + {b}_{y} + 1} + {y}_{1} ) , {y}_{2} , … , {y}_{n} , 0 , {l}_{y} 〉 & \begin{matrix}if {b}_{y} \neq 0 , \\ n > 0\end{matrix}\end{matrix}$

According to Table 1, a label correction operator is used both in computing an offset table and in correcting labels.

The label correction operator corrects a prefix-based label of a specific element using tuples of an element prior to the specific element. As shown in Table 1, there are three ways to corrects labels. For example, suppose that there are two tuples X and Y and that X is <1.1, 0, 2>.

If Y: <1.1, 0, 1>, by=0, which corresponds to the first case in Table 1. Labels are corrected as <1.1, 0, 2>⊙<1.1., 0, 1>=<1.1.(2+1).1, 0, 1>, so the final label is <1.1.3.1, 0, 1>.

If Y: <empty, −1, 1>, by≠0, n=0, which corresponds to the second case in Table 1, and labels are corrected as <1.1, 0, 2>⊙<empty, −1, 1>=<1, 0, 2>.

If Y: <1.1, −1, 1>, by≠0, n>0, which corresponds to the third case in Table 1, and labels are corrected as <1.1, 0, 2>⊙<1.1.,−1, 1>=<1.(1+1).1, 0, 1>. The label correction operator ⊙ does not allow both commutative law and associative law. That is, X⊙Y≠Y⊙X and X⊙(Y⊙Z)≠(X⊙Y)⊙Z.

In an interval-based labeling technique, an offset table has columns of label value, basis value and inner order value, and tuples thereof are configured as below: The first tuple is given as <empty, 0, 0>, and the following tuples are a value that is obtained by computing offset information corresponding to the first data block to the (i−1)th data block using ⊙. The last partial label of an XML element in the ith data block, which has a basis value of b, is computed as T′=Ti⊙<L,b,_>, so the partial label is obtained as the final label L′. Herein, Ti denotes the ith tuple in the offset table, and L′ is a label of a resultant tuple T′. For example, the item element of the data block 2 803-2 in Table 1 is labeled with 1 through the partial labeler 2 802-2, and a basis value thereof is 0. Thus, the outcome from the partial labeler 2 802-2 is recorded as <1,0,_> The item element belongs to the data block 2 803-2, so a label of the item element is corrected with reference to the second tuple value in the offset table. It is represented by T′=<1.1, 0, 1>⊙<1, 0, _{—}>=<1.1.(1+1), 0, _>. Thus, the final label L′ becomes 1.1.2.

An interval-based labeling scheme and a prefix-based labeling scheme, both of which are typical labeling schemes used for a large XML document, are capable of efficiently performing a labeling operation in a dispersed environment in parallel.

In addition, by applying a technique that balances labeling workloads between dispersed nodes, it is possible to prevent processing delay that may be caused by disproportionately high workloads assigned to a specific node.

Further, by performing correction during parallel labeling operations in order to prevent any loss of structural information of each element included in an XML document, it is possible not only to obtain a result as the same as that can be achieved using a serial algorithm, but also to expedite the whole process by using parallelization.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A parallel tree labeling apparatus for processing an eXtensible Markup Language (XML) document, the apparatus comprising:
a data distributor configured to divide the XML document into a plurality of data blocks; and
a labeling component configured to receive elements of each of the plurality of data blocks, perform a labeling procedure on the plurality of data blocks in parallel, and generate a final label by combining partial labels.

2. The parallel tree labeling apparatus of claim 1, wherein the labeling component is a program written in accordance with a MapReduce programming model or a module that functions as the program.

3. The parallel tree labeling apparatus of claim 1, wherein the labeling component is further configured to comprise:
a plurality of partial labelers, each of which is configured to perform a partial labeling procedure on elements of a data block allocated thereto; and
a labeling completer configured to generate the final label by collecting groups of partial labels, wherein the partial labels are grouped by shuffling the partial labels on which the partial labeling is performed in parallel by the plurality of partial labeler.

4. The parallel tree labeling apparatus of claim 3, wherein each of the plurality of partial labelers is configured to perform a partial labeling procedure on a data block allocated thereto, and record offset information required for combining and correcting partial labels when the labeling completer computes the final label.

5. The parallel tree labeling apparatus of claim 3, wherein each of the plurality of partial labelers is further configured to:
record a numeric tag value of each tag when reading tags in a data block allocated thereto;
obtaining relative level information in the allocated data block by computing a number of start tags and end tags, which are not coupled as a pair;
recomputing a label using a number of numeric tag values that are not coupled with different numeric tag values; and
recording a label of a last element in the allocated data block.

6. The parallel tree labeling apparatus of claim 3, wherein the labeling completer is further configured to generate the final label by correcting labels based on the offset information when combining the partial labels, wherein the offset information is structural information required for correction when generating the final label by combining the partial labels.

7. The parallel tree labeling apparatus of claim 3, wherein the labeling completer is further configured to generate the final label by correcting the partial labels using a correction operator when combining the partial labels.

8. The parallel tree labeling apparatus of claim 1, further comprising:
a statistics processor configured to read the XML document divided by the data distributor, and aggregate appearance frequencies of elements for each tag name in each data block of the XML document

9. The parallel tree labeling apparatus of claim 8, wherein the statistics processor is a program written in accordance with a MapReduce programming model, or a module that functions as the program.

10. The parallel tree labeling apparatus of claim 8, wherein the statistics processor is further configured to comprise:
a plurality of tag name appearance frequency estimators, each of which is configured to read a data block allocated thereto and estimate appearance frequencies of elements having a same tag name among entire elements in the allocated data block; and
an appearance frequency aggregator configured to receive thee appearance frequencies from each of the plurality of tag name appearance frequency estimators, and aggregate the appearance frequencies of elements for each tag name in the entire XML document.

11. The parallel tree labeling apparatus of claim 8, further comprising:
a data redistributor configured to distribute a volume of data using an aggregation result of the appearance frequencies computed in the statistics processor, so that an equal amount of workloads is assigned to each task of the label component.

12. The parallel tree labeling apparatus of claim 11, wherein the data redistributor is further configured to:
compute average appearance frequencies of elements for each tag name in the XML document by reading appearance frequencies of the elements for each tag name;
in response to a tag name for which elements have appearance frequencies greater than the average appearance frequencies, dividing a list of the elements having the tag name into a plurality of lists of elements; and
allocating a partition key to each of the divided lists of elements.

13. The parallel tree labeling apparatus of claim 12, wherein the labeling component is further configured to perform a shuffling operation according to a partition key provided by the data redistributor, so that an equal amount of workloads is allocated to each task for performing the labeling procedure.

14. A parallel tree labeling method for processing an eXtensible Markup Language (XML) document, the method comprising:
dividing the XML document into a plurality of data blocks; and
receiving elements of each of the plurality of data blocks, performing a labeling procedure on each of the plurality of data blocks, and generating a final label by combining partial labels.

15. The parallel tree labeling method of claim 14, wherein the generating of the final label comprises:
performing the labeling procedure on elements of each allocated data block on data block-by-data block basis; and
generating the final label by collecting groups of partial labels, wherein the partial labels on which the labeling procedure is performed in parallel are grouped through a shuffling operation.

16. The parallel tree labeling method of claim 15, wherein the generating of the final label further comprises performing a partial labeling procedure and recording offset information required for combining and correcting the partial labels when computing the final label.

17. The parallel tree labeling method of claim 16, wherein the recording of offset information comprises:
recording a numeric tag value of each tag when reading tags in each allocated data block;
obtaining relative level information in each data block by counting a number of start tags or end tags that are not coupled as a pair;
recomputing a label using numeric tag values that are not coupled with different numeric tag values; and
recording a label of a last element in each data block.

18. The parallel tree labeling method of claim 15, wherein the generating of the final label comprises generating the final label by collecting partial labels that are shuffled with reference to a partition key.

19. The parallel tree labeling method of claim 15, wherein the generating of a final label comprises generating the final label by correcting the partial labels based on the offset information when combining the partial labels, wherein the offset information is structural information containing information that is required for correcting the partial labels when combining the partial labels to generate the final label.

20. The parallel tree labeling method of claim 15, wherein the generating the final label comprises generating the final label by correcting the partial labels using a correction operator when combining the partial labels.
